(19) United States
(12) Patent Application Publication
(10) Pub. No.: US 2026/0319249 A1
(43) Pub. Date: Oct. 15, 2026

(54) STRAY LIGHT FILTER FOR HOLOGRAPHIC HUDS

(71) Applicant: Carl Zeiss Jena GmbH, Jena (DE)

(72) Inventors: Siemen KUEHL, Jena (DE); Ingo STEINGOETTER, Jena (DE)

(21) Appl. No.: 19/117,065

(22) PCT Filed: Sep. 26, 2023
(86) PCT No.: PCT/EP2023/076556

§ 371 Date: Mar. 30, 2025

(30) Foreign Application Priority Data
Sep. 30, 2022 (DE) 102022210395.5
Dec. 21, 2022 (DE) 102022214243.8

(51) Int. Cl. G02B 27/01; G02B 27/28

(52) U.S. Cl. CPC G02B 27/0103; G02B 27/288; G02B 2027/0118

(57) ABSTRACT

A scattered-light-reduced HUD with a holographic component for beam adaptation is provided. At least one band-pass filter is arranged in a beam path between the holographic component and a provided eyebox of the HUD. The band-pass filter is permeable for visible light in at least one first spectral range, which comprises at least one spectral range refracted by the holographic component for beam adaptation. Also provided is a corresponding holographic component for a scattered-light-reduced HUD, a manufacturing method for the holographic component and a holographic component produced by said method.

### PRIORITY

This application claims the priority of German patent application DE 10 2022 210 395.5, filed Sep. 30, 2022 and German patent application DE 10 2022 214 243.8, filed Dec. 21, 2022, both of which are hereby incorporated herein by reference in their entirety.

### FIELD

The invention relates to a stray light-reduced HUD having a holographic beam adaptation component. At least one bandpass filter is arranged here in a beam path between the holographic component and a provided eyebox of the HUD. The bandpass filter is transmissive for visible light in at least a first spectral range, which comprises at least one spectral range diffracted by the holographic beam adaptation component.

The invention also relates to a corresponding holographic component for a stray light-reduced HUD.

The invention also relates to a manufacturing process for the holographic component, and to a holographic component manufactured thereby.

### BACKGROUND

Head-up displays (HUD) are display systems in which the information to be displayed is projected into the user's field of view, with it being possible at the same time to view the environment, which is likewise in the field of view. By way of example, HUDs are known from motor vehicles or aircraft. In vehicles, the information to be displayed may be projected, for example via the windscreen of the vehicle, into the user's eye area, into the eyebox, as it is known. HUDs may be implemented on the basis of a multiplicity of different systems, most of which already belong to the prior art.

An HUD may usually comprise a picture generating unit (PGU) or a projector, and also a projection surface (often the windscreen) and other optical beam adaptation components. By way of example, an image may be generated using a PGU or projector. The image is projected onto the projection surface (for example by way of the other optical components) and, from there, on into the eyebox, as it is known. This eyebox is preferably a plane or a spatial region in which the projected image is perceptible to an observer. The projected image may comprise a virtual and/or real image. The at least one virtual image plane, that is to say the plane on which the virtual image is generated, may for example be located behind the projection surface, that is to say on the other side of the projection surface than the eyebox.

In addition to “conventional” projection systems having “conventional” optical components, it is possible to use HUDs based on holographic components.

In contrast to normal imaging, phase relationships of the light coming from the object are also stored in holography, in addition to the intensity of the imaged object. These phase relationships contain additional spatial information, meaning that it is possible for example to generate a three-dimensional impression of the image. This is effected with the aid of interference of light beams while the object is being recorded. The object is illuminated using coherent light, which is reflected and scattered by the object. The resulting wave field, which is known as object wave, is superimposed with light coherent with the object wave (what is known as the reference wave, typically from the same light source, for example a laser), and the wave fields interfere with one another as a function of their phase relationship. The resulting interference pattern is recorded using a light-sensitive layer, for example, and consequently the information contained in the phase is also stored. For reconstruction purposes, the resultant hologram is illuminated using a light wave identical or similar to the reference wave, and this light wave is subsequently diffracted by the recorded interference patterns. The original wavefront of the object wave may thus be reconstructed. There are various types of holograms, for example what are known as volume holograms. Volume holograms preferably have a thickness that may likewise be used for storing holographic image information. Volume holograms may in particular be white light holograms, since they may exhibit wavelength selectivity due to wavelength-selective interference.

Holograms may be for example transmission and reflection holograms, which generate this reconstruction in each case either in transmission or in reflection. In the case of a transmission hologram, for example, if an observer is located on an opposite side of the hologram from the light source and observes the hologram, the imaged object for example appears in front of the observer in three-dimensional fashion. In the case of a reflection hologram, for this purpose the observer must preferably be located on the same side as the light source. Reflection holograms preferably have a wavelength-selective efficiency in order to diffract the light in a specific direction (along a specific angle). The word hologram is preferably used here as being synonymous with the holographic structure that generates the light diffraction. Generally speaking, a “hologram” sometimes denotes the in particular three-dimensional image that is generated. However, a person skilled in the art knows from the context what the term “hologram” should be understood to mean.

Besides the three-dimensional representation of objects, holograms may also be used as what are known as holographic optical elements (HOEs), the holographic properties of which may be used for the optical system of apparatuses. By way of example, conventional lenses, mirrors and prisms may be replaced by HOEs. In other cases, HOEs are used as special diffraction gratings. HOEs have for example a spectral selectivity and/or a selectivity in relation to the angle of incidence. At the same time, they may be completely or partly transparent to other spectral ranges and/or angles of incidence. Holograms also enable a combination of representation and light shaping.

In particular, the use of these HOEs for beam shaping is practical for HUDs. Since there is a great degree of freedom in the type of desired beam shaping with little dependence on the dimensions of the HOE, it is thus possible to achieve a desired beam adaptation without requiring a large amount of installation space. This aspect is particularly beneficial for motor vehicles, where installation space is often limited for many reasons. HOEs may also be used to reduce and/or correct aberrations. PCT applications PCT/EP2022/055513 and PCT/EP2022/066787 describe holograph-based wavefront manipulators, which are particularly preferably understood to mean a holographic beam adaptation component in accordance with this document and the content of which is hereby incorporated into this application.

In head-up displays, it is essential to deflect or even suppress interfering reflections from the sun that are reflected in the direction of the driver via components of the HUD and may dazzle the driver. This effect occurs not only in conventional systems, but also in holographic HUDs. However, in comparison to conventional HUDs, interfering reflections may additionally occur due to diffraction on the holograms. It may in particular be the case here that, in addition to the lighting beams of the HUD, light beams from other spectral ranges and/or other directions are likewise guided into the eyebox.

Although beam-deflecting glare traps, as they are known, are already known in the prior art and allow ambient light to be deflected in the direction outside the eyebox, these are not suitable for suppressing interfering reflections caused by diffraction on a holographic component of the HUD on a targeted basis. The prior art does not disclose any solution for this problem.

### SUMMARY

One object of the invention is therefore to provide an HUD and a holographic component for an HUD without the disadvantages of the prior art. One object of the invention is in particular to provide an HUD and a holographic component for an HUD that, in a simple, compact and effective manner, minimize interfering reflections of ambient light that are diffracted into the eyebox by the holographic component. Another object of the invention is to provide an improved HUD and an improved holographic component for a HUD that enable reliable and easy recognition of the displayed information without dazzling the user and improve the contrast of the HUD.

In a first aspect, provided herein is a stray light-reduced head-up display (HUD) having a holographic beam adaptation component, wherein at least one bandpass filter is arranged in a beam path between the holographic component and a provided eyebox of the HUD, in particular a holographic component and an included projection surface of the HUD. The bandpass filter is transmissive for visible light in at least a first spectral range, which comprises at least one spectral range diffracted by the holographic beam adaptation component, and is preferably configured to suppress visible light outside the at least first spectral range.

The stray light-reduced HUD is in particular any normal HUD that advantageously, by virtue of the features of the invention, in particular by virtue of the bandpass filter, deflects less ambient light into the eyebox or safety eyebox compared to an HUD without these features. The term “stray light” should be understood here in the broadest sense of the term “scatter”, which comprises any kind of interaction between matter and electromagnetic radiation, in particular light. This scatter may for example comprise the phenomenon of diffraction and/or reflection.

Preferably, in this document, the terms “electromagnetic radiation” and “light” are used synonymously and denote in particular electromagnetic radiation comprising the visible spectral range. However, it may also encompass the ultraviolet spectral range and the near-infrared range. Preferably, light in this sense comprises a spectral range (specified as wavelength in nanometers—nm) from 100 nm to 3000 nm, more preferably 280 nm to 1400 nm and in particular 380 nm to 780 nm. It is obvious to a person skilled in the art that a spectral range may be specified not only as a frequency range in Hertz (Hz), but also, in the same way (through an appropriate conversion), as a wavelength range in nm. Wavelength range and spectral range may preferably be used synonymously in this document.

The beam path in particular comprises the volume taken up by the beams used to operate the HUD. Typically, the beam path extends from the light source, over all optical components of the HUD (for example for beam guidance), as far as an eyebox of the HUD.

The eyebox comprises in particular an area or volume from which the HUD is to be observed. By way of example, the eyes of the at least one observer may/should then be located in this volume, hence the name eyebox. By way of example, the eyebox may have dimensions of 150 mm×150 mm in one area.

The safety eyebox preferably comprises an area or a volume that is enlarged compared to the eyebox, for example to 300 mm×300 mm, in order to cover a safety margin from which the observation may likewise take place in exceptional cases.

In this document, the term “eyebox” may also be used as eyebox together with safety eyebox.

HOEs have already been introduced above. A holographic beam adaptation component may be one variant of an HOE. A holographic beam adaptation component may comprise at least one hologram, in particular at least one HOE, which, as part of the HUD, carries out an optical function, preferably a beam adaptation function, for example beam shaping, beam deflection/guidance and/or an optical (spectral, angle-selective and/or polarization-selective) filter function. The function is preferably carried out here in the spectral range diffracted for beam adaptation purposes. There may also be multiple spectral ranges diffracted for beam adaptation purposes within which the beam adaptation function is carried out.

The spectral range is preferably a contiguous range, such that multiple spectral ranges preferably comprise multiple non-contiguous spectral ranges.

Beam shaping preferably means influencing the shape of the beam. Beam shaping may in particular comprise manipulating the wavefronts. Beam shaping comprises for example collimating, focusing, defocusing, increasing divergence, broadening the beam diameter, reducing the beam diameter, generally changing the size and/or shape of the beam cross section or the like.

Beam guidance or deflection describes in particular a deviation of the beam path from an undisturbed electromagnetic (light) beam that is forced by an optical component. By way of example, beam guidance may comprise beam folding in order to guide the beam from the light source to the eyebox under given constraints (for example installation space, size of the eyebox, size of the image, position of the image, etc.).

The holographic beam adaptation component is preferably configured to adapt the light beam (synonymously: the bundle of light rays, the light beams) of at least one spectral range (of the spectral range diffracted for beam adaptation purposes) in accordance with the functional determination of the holographic component.

However, the holographic beam adaptation component may preferably be configured to adapt the light beam (synonymously: the bundle of light rays, the light beams) of multiple (for example two or three) spectral ranges (that is to say multiple spectral ranges diffracted for beam adaptation purposes) in accordance with the functional determination of the holographic component.

Typically, the holographic component will be configured to carry out a beam adaptation of the at least one spectral range emitted by the at least one light source of the HUD. Therefore, the at least one diffraction grating of the holographic beam guidance component is preferably designed to diffract light in this spectral range in accordance with the desired functionality. In addition, the spatial arrangement of the HUD components in relation to one another is usually fixed, meaning that not only is the diffracted spectral range fixed, but the direction from which the light to be diffracted is incident on the holographic component is as well. This direction may preferably also be described by an angle or an angular spectrum around this angle if more than one direction is involved, which is generally the case with the flat extent of the optical components, a desired field of view and beam guidance that is not perfectly collimated. The holographic component therefore typically has a centroid angle and/or an angular spectrum that matches the angle or angular spectrum from which the light to be diffracted is incident on the holographic component.

The centroid angle is preferably the angle for which the holographic component has the maximum diffraction efficiency. The angular spectrum of the holographic component is preferably an angular range having an orientation given by the centroid angle. The angular spectrum of the holographic component is in particular the (contiguous) range of angles around the centroid angle for which the holographic component likewise performs the (desired) diffraction. This angular spectrum may be defined for example in that the diffraction efficiency there has at least 50% of the maximum diffraction efficiency. The angular spectrum may be defined here along or parallel to a cutting plane with the centroid angle if for example the holographic component diffracts only light the direction of which is within or parallel to this plane. However, the angular spectrum may also be defined along multiple cutting planes with the centroid angle (or parallel thereto) and may in the process also differ in each case. By way of example, the angular spectrum may be defined along or parallel to two mutually perpendicular cutting planes with the centroid angle.

Preferably, the centroid angle and/or angular spectrum of the holographic components are linked to the spectral range diffracted thereby, meaning that a typical description of the holographic component is given by the specification of the centroid angle and the angular spectrum distributed around it for a (at least one) specific diffracted spectral range.

The holographic component is thus preferably configured to diffract light of at least one spectral range and of at least one angular spectrum in order to achieve the desired beam adaptation. By way of example, the light source may emit light in the red (R), green (G) and blue (B) spectral range to produce a color or white-light HUD. The light has a respective spectral distribution with a certain width in the respective spectral range. The holographic component is then preferably configured to diffract light in these spectral ranges accordingly, the light coming from the direction of the light source or another upstream component of the HUD (thus light having a given angular spectrum and/or centroid angle).

A bandpass filter preferably denotes a filter that is largely transmissive for electromagnetic radiation in a spectral range. The frequency or wavelength ranges below and above the transmission range are preferably not transmitted or are attenuated significantly here.

It may also be preferable for the bandpass filter that is used here to allow the passage of electromagnetic radiation from more than one first spectral range, for example from a second, third or even more spectral ranges, and to block or attenuate the radiation between these spectral ranges. This is particularly desirable if the holographic component diffracts more than one spectral range for beam adaptation purposes.

In this case, the bandpass filter is transmissive for visible light in at least a first spectral range (preferably also in a second and particularly preferably also in a third spectral range), which comprises at least one spectral range diffracted by the holographic beam adaptation component, and is preferably configured to suppress visible light outside the at least first spectral range.

As discussed above, the holographic component is designed for at least one spectral range diffracted by the holographic beam adaptation component and/or an angular spectrum (and the corresponding centroid angle) diffracted by the holographic beam adaptation component. Light from other spectral ranges, from other angles and/or having other angular spectra is advantageously either not diffracted at all by the holographic component or is diffracted differently than the light for the HUD. Nevertheless, it is possible for light from other spectral ranges and/or other directions (thus other angles and/or angular spectra) likewise to be diffracted by the holographic component in such a way that this light is steered directly from the holographic component or in conjunction with other components of the HUD in the direction of the eyebox and may thus generate interfering light in the eyebox. This is in particular due to the fact that the diffraction grating contained in the holographic component may also generate constructive interference, and thus diffracted light, in a wide variety of directions for other angles and/or wavelengths of incident light. This is an inherent property of the diffraction grating and cannot be prevented completely.

Due to the fact that the bandpass filter is then transmissive for visible light in at least a first spectral range, which comprises at least one spectral range diffracted by the holographic beam adaptation component, and is preferably configured to suppress visible light outside the at least first spectral range, it is possible to substantially prevent or suppress a situation whereby light from other spectral ranges than that of the at least first spectral range reaches the holographic component and may thus be diffracted thereby in the direction of the eyebox.

Due to the fact that the bandpass filter preferably functions in different directions and/or has an at least partially suppressing effect, it is likewise also possible to prevent light from other spectral ranges that reach the holographic component in spite of filters and are diffracted thereby passing through the bandpass filter, since the bandpass filter for example also functions in the direction given after diffraction on the holographic components or has an at least partially suppressing effect. By way of example, partial or partially may mean 40% suppression, 30% suppression, 20% suppression or 10% or less suppression. The bandpass filter thus preferably acts so as to suppress light from unwanted spectral ranges in the direction of the holographic component and so as to suppress light from unwanted spectral ranges following diffraction by the holographic component. The arrangement of the bandpass filter in the beam path between the holographic component and a provided eyebox of the HUD thus makes it possible to greatly reduce or eliminate interfering light diffracted by the holographic component.

In one preferred embodiment, the suppression comprises an attenuation by at least a factor of 10, preferably a factor of 20 and in particular a factor of 100. The intensity irradiating onto the bandpass filter is in particular used here as a reference and is compared with the intensity of the same light passing through the bandpass filter (or of the proportion thereof that has passed through the filter). The attenuation may in this case be different for different angles of incidence and/or spectra, wherein preferably the least attenuated angle or the least attenuated spectrum is used to determine the attenuation.

It has been found that, even for an attenuation by a factor of 10, it is possible to achieve sufficient elimination of interfering light with low demands on the bandpass filter. This solution is thus particularly simple and inexpensive.

With an attenuation of a factor of 20, it is possible to achieve a particularly good compromise between bandpass filter quality and improved attenuation. This solution is thus particularly efficient.

With an attenuation of a factor of 100, it is possible to achieve a reduction of interfering light that offers a high level of reliability and operability in all conditions, including in critical applications.

In another preferred embodiment, the first spectral range has a full width at half maximum of at most 20 nm, preferably at most 10 nm and in particular at most 5 nm.

These values may each be combined with one of the abovementioned preferred values for attenuation in a filter in order to exhibit particularly advantageous filter properties.

A person skilled in the art knows how to determine the full width at half maximum of a spectral range. The full width at half maximum is preferably the spectral range within the transmission range of the filter that is between the two spectral values (lower and upper value) at which in each case the transmission of the bandpass filter has dropped to half the maximum.

It is clear to a person skilled in the art that the properties mentioned for the first spectral range in this document, such as for example here full width at half maximum, are also intended to apply to the second and any further spectral range, insofar as the bandpass filter is also transmissive thereto.

The full widths at half maximum may advantageously be selected depending on the spectral range diffracted by the holographic beam adaptation component, such that this is not attenuated or is attenuated only partially (partially may mean for example 40% or less, 30% or less, 20% or less or 10% or less) by the filter.

However, it may also be the case that the diffracted spectral range is significantly narrower than the mentioned full widths at half maximum and the full width at half maximum of the bandpass filter is selected for other reasons (for example cost-benefit calculation).

It is obvious to a person skilled in the art here that a narrower full width at half maximum is often more expedient in terms of interfering light suppression.

In another preferred embodiment, an acceptance angular spectrum of the bandpass filter comprises the solid angle 2π sr.

The acceptance angular spectrum preferably denotes the angular range or the angular ranges for which the filter has the desired functionality or the one described (that is to say defined) here.

The acceptance angular spectrum may in particular define the at least one angular range for which the filter allows light to pass at all, such that the light outside the acceptance angular spectrum is advantageously suppressed.

The acceptance angular spectrum may generally be defined along a plane, but it may also be defined along multiple planes and differ in each case. In this embodiment, the acceptance angular spectrum comprises a solid angle and is therefore advantageously defined along three planes or in three-dimensional space.

The solid angle is preferably the three-dimensional counterpart to the commonly used two-dimensional angle, which lies within a plane. It preferably describes the proportion of three-dimensional space that lies for example inside a volume able to be described by a partial surface of a spherical surface and its connecting lines to the center of the sphere. The solid angle is preferably defined as the surface area of the partial surface divided by the radius of the sphere squared. This dimensionless number is preferably characterized by the unit steradian (sr) as a solid angle.

Preferably, this is understood here to mean the solid angle of a cone, wherein the partial surface of the spherical surface is in particular a circle.

Preferably, the cone is rotationally symmetrical about the reference axis, as it is known, which is preferably a normal to the surface of the holographic component or a cover glass (see below), in particular a normal in the (geometric) centroid of the surface of the component or the cover glass when the surface of the component or the cover glass is curved. However, the solid angle may generally also be defined independently of a spatial axis of the filter.

The solid angle 2π sr (or 2×π sr) preferably describes the solid angle of a hemisphere and thus in particular of a half-space. This hemisphere is also preferably rotationally symmetrical about the abovementioned reference axis.

A half-space is preferably a subset of three-dimensional space that is delimited by a plane. The plane here preferably forms the surface of the holographic component or the cover glass, if this is flat, and more generally (including in the case of curved surfaces) preferably the tangent of the surface at the point of intersection with the reference axis.

It is thus preferably possible to ensure that the bandpass filter functions in the desired or defined manner for a large angular range. In addition, for a multiplicity of possible angles of the beam path of the HUD, the functionality thereof may thus remain unaffected by the filter.

In another preferred embodiment, the acceptance angular spectrum of the bandpass filter preferably comprises an angular spectrum of 10°, more preferably of 8°, even more preferably of 6°, and in particular of 5°.

All of these values may also be understood to mean an upper limit of the angular spectrum, that is to say 10° or less, more preferably 8° or less, even more preferably 6° or less, and in particular 5° or less.

In the most general case, the angular spectrum is preferably a contiguous range of angles that is defined in at least one plane, and is preferably defined in two planes (in this case also differently between the planes) and in particular in three-dimensional space. This angular spectrum may preferably be defined as an angular range that is arranged symmetrically about an axis. This may be for example the abovementioned reference axis. However, it may also be preferable for this angular range to be arranged symmetrically about a different axis than the reference axis described above; by way of example, the axis may be the centroid angle of the angular spectrum diffracted by the holographic beam adaptation component. One example of an angular spectrum of 8° is an angular range of ±4° around the centroid angle in all planes rotated about the centroid angle, wherein the centroid angle for example forms an angle of 30° with the reference axis in a plane.

The preferred angles are suitable for creating a desired field of view (FoV) in an eyebox, and at the same time the manufacture of the bandpass filter is not excessively complex. In particular in the case of a bandpass filter comprising a layer system, it may be difficult to achieve a certain transmission and suppression spectrum over a wider spectral range. By way of example, this FoV may be between 15° and 25° in the horizontal direction and 5° in the vertical direction, since the angles that define the FoV in the eyebox may be significantly larger than at the bandpass filter if this is arranged for example on or at the cover glass. This may depend for example on the installation position and shape of the filter or cover glass. It is thus advantageous for the filter to be installed at a location where the angular spectrum of the HUD beam path is relatively small. Advantageously, within the HUD, this is the case where it also makes sense from a reflection avoidance perspective.

Due to the different FoV depending on direction, it may be useful for the acceptance angular spectrum in one plane in relation to the filter to be different than in another plane. By way of example, there may be a first plane of the diffracted light beams at the filter, wherein the light beams in this plane later generate the angular spectrum (and thus the FoV) in the horizontal plane of the eyebox, and a second plane of the diffracted light beams at the filter, wherein the light beams in this second plane later generate the angular spectrum in the vertical plane of the eyebox. Then, for example, the acceptance angular spectrum may be 25° in the first plane and 10° in the second plane.

In another embodiment, the acceptance angular spectrum of the bandpass filter is configured to generate a desired FoV of the HUD.

By way of example, this FoV may be between 15° and 25° in the horizontal direction and 5° in the vertical direction.

In another preferred embodiment, the acceptance angular spectrum comprises the centroid angle of the angular spectrum diffracted by the holographic beam adaptation component.

It is thus particularly easy to ensure that the beam guidance for the HUD is not negatively affected by the bandpass filter.

In another preferred embodiment, the acceptance angular spectrum of the bandpass filter comprises an angular spectrum diffracted by the holographic beam adaptation component and/or its centroid angle and is at most 10°, more preferably at most 5° and in particular at most 2° larger than the diffracted angular spectrum.

This embodiment makes it possible to ensure a high-quality HUD with a corresponding FoV, wherein the bandpass filter at the same time particularly effectively suppresses interfering light, which is blocked by the filter due to a deviating angular spectrum.

In another preferred embodiment, the holographic component comprises a wavefront manipulator to be arranged in the beam path of the HUD between a picture generating unit and a projection surface.

In HUDs, in particular in vehicles, aberrations occur as a result for example of the curvature of the projection surface and/or as a result of compact arrangements in a small installation space with, under certain circumstances, severe tilting of individual components with respect to one another and correspondingly complexly folded beam paths. The aberrations that may typically occur are for example distortion, defocus, tilting, astigmatism, curvature of the image plane, spherical aberrations, higher astigmatism and coma.

A wavefront manipulator is advantageously used to at least partially correct and minimize imaging aberrations and to provide an improved head-up display, which may at the same time be particularly compact. For this purpose, as the name suggests, the wavefronts of the light beams of the HUD are manipulated appropriately.

The wavefront manipulator in this case preferably comprises a holographic arrangement (the wavefront manipulator should therefore be regarded as a holographic beam guidance component), which in turn has at least two holographic elements. The at least two holographic elements are arranged one behind another, preferably one directly behind another, in the beam path. It is particularly preferable for no further optical element or component to be arranged between the at least two holographic elements. The at least two holographic elements are furthermore designed to be reflective for at least the spectral range diffracted by the holographic beam adaptation component and preferably a centroid angle and an angular spectrum. Preferably, the holographic elements are otherwise designed to be transmissive, in other words transmissive for other spectral ranges, at least if these have the same angle of incidence and/or the same angular spectrum. Preferably, a first holographic element comprises at least one hologram for reflection assigned to a hologram of a second holographic element for reflection. The at least two holographic elements are, in other words, preferably designed such that light of the diffracted spectral range, which light is diffracted in reflection by a first holographic element and is preferably incident at the centroid angle and the angular spectrum of the holographic component, is then reflected in turn by the second holographic element, wherein the desired wavefront manipulation is achieved in conjunction between the first and second element.

Using reflection holograms advantageously makes it possible to achieve diffraction in a more wavelength-selective manner compared to transmission holograms, such that in particular fewer color aberrations occur and a white image is thereby able to be generated better from the color channels. By placing two reflection holograms one behind another, it is advantageously still possible to achieve a transmission arrangement and distribute the manipulation to two holograms.

The at least one holographic arrangement is preferably designed to diffract light from a plurality of spectral ranges diffracted for beam adaptation purposes. For this purpose, multiple holograms may be contained in each holographic element (referred to as hologram stack), these each diffracting light from a spectral range, and/or each holographic element may comprise what is referred to as a multiplex hologram, which diffracts light of multiple wavelengths.

Preferably, each of the at least two holographic elements comprises a number, for example a plurality, of holograms. Each hologram is in this case designed for at least one spectral range. A holographic element may comprise for example multiple holograms, which may be arranged one on top of another as a stack. As an alternative thereto, a holographic element may comprise at least one hologram that is designed for at least two spectral ranges. Preferably, the one or more holograms are recorded for three different spectral ranges of a defined color space, for example for the RGB color space or a CMY color space. Here, C stands for cyan, M stands for magenta and Y stands for yellow.

The individual, mutually differing holograms of a holographic element may be arranged next to one another and/or one behind another in relation to a center line or center axis, which may coincide with the optical axis, or in relation to some other defined geometric parameter of the holographic element.

The holographic arrangement may comprise a first holographic element and a second holographic element, wherein a plurality of the holograms or all of the holograms of the respective holographic element are configured identically or the same, with the exception of the spectral range for which they are designed.

Preferably, the first holographic element is arranged mirror-symmetrically with respect to the second holographic element in relation to the arrangement of the individual holograms. By way of example, the first holographic element may comprise a hologram designed for the red spectral range, a hologram designed for the green spectral range and a hologram designed for the blue spectral range, which are arranged one on top of another in the order mentioned. The second holographic element may likewise comprise a hologram designed for the red spectral range, a hologram designed for the green spectral range and a hologram designed for the blue spectral range, which are likewise arranged one on top of another in this order. In the case of a mirror-symmetrical arrangement, the first holographic element and the second holographic element are arranged one on top of another or adjacent to one another in such a way that for example the hologram of the first holographic element recorded for the red spectral range is arranged directly adjacent to the hologram of the second holographic element recorded for the red spectral range.

As an alternative thereto, the arrangement of the holograms of the first holographic element may be identical to the arrangement of the holograms of the second holographic element in relation to a defined direction. By way of example, both holographic elements may have holograms arranged in the order RGB (R—hologram recorded with red light, G—hologram recorded with green light, B—hologram recorded with blue light) in relation to a defined direction, which are arranged against one another in such a way that the hologram R of one holographic element adjoins the hologram B of the other holographic element. Any other mutually different arrangements are likewise possible, for example RGB adjoining or adjacent to GBR, etc.

In the above description, the holographic arrangement may preferably be understood to mean that it comprises two holographic elements that are arranged one directly behind another along the beam path, wherein a first holographic element is designed for the first “reflective” diffraction and the second holographic element is designed for the “reflective” diffraction of light that has already been diffracted beforehand by the first holographic element. Advantageously, for this purpose, the first holographic element is located downstream of the second holographic element along the beam path. In this case, each holographic element (or the at least one hologram that they comprise) may be designed for one or more spectral ranges.

For the purposes of manipulating wavefronts for more than one spectral range, provision may alternatively and preferably be made for more than one pair of holographic elements to be present, wherein each pair that is designed for the same spectral range is arranged one directly behind another along the beam path. In this case, not only is at least one hologram of the first or another holographic element assigned to at least one hologram of the second or another holographic element, but the pairs of holographic elements themselves, which are each designed for the same spectral range, are assigned to one another. By way of example, the holographic arrangement may for this purpose comprise a pair of holographic elements for the red spectral range that are arranged one directly behind another, then a pair of holographic elements for the green spectral range that are arranged one directly behind another, and then another pair of holographic elements for the blue spectral range that are arranged one directly behind another. These respective pairs are preferably likewise arranged one directly behind another in the beam path.

The holographic arrangement may be designed in the form of at least one layer or at least one film or at least one substrate, for example in the form of at least one volume hologram, or in the form of at least one plate. In addition or as an alternative thereto, the holographic arrangement may have a planar surface or a curved surface. The holographic arrangement may be arranged or have been arranged for example at, on or below a surface of a cover glass or of some other optical component that is present anyway.

In this way, no additional installation space is taken up. By way of example, the wavefront manipulator may comprise an optical component of transmissive design, which is designed to be arranged in the beam path between the holographic arrangement and the projection surface. In this case, the holographic arrangement may preferably be arranged at a surface—which faces away from the projection surfaces—of the optical component of transmissive design. Both the optical component of transmissive design and the holographic arrangement may be designed to be curved, preferably with the same curvature. The abovementioned optical component of transmissive design may be for example what is known as a glare trap, which is usually arranged at a position between a windscreen and a head-up display and which is designed to reflect sunlight in a defined direction so that it is not reflected in the direction of the eyebox via the head-up display. In this design variant, the holographic arrangement and the glare trap are preferably designed with the same curvature and arranged directly adjacent to one another.

The holographic arrangement is preferably designed for a plurality of angles of incidence and/or for a plurality of angle of incidence ranges that do not overlap one another. By way of example, it is thus possible to achieve different image planes in a HUD through the different angles or angular spectra. For this purpose, the holographic arrangement may for example comprise separate pairs of holographic elements for each angle or for each irradiated angular spectrum. As an alternative, a single pair of holographic elements may also be designed for multiple irradiated angles or angular spectra, for example by way of in each case multiple holograms that are present and each designed for an irradiated angle or an irradiated angular spectrum.

In one preferred variant, the wavefront manipulator according to the invention comprises at least one optical element that has a freeform surface, that is to say an optically effective freeform surface, and is designed to be arranged in the beam path between the picture generating unit and the holographic arrangement. The optical element comprising the freeform surface contributes to an improvement in resolution by way of a corresponding design of the freeform surface and allows a targeted correction of imaging aberrations. Furthermore, the optical element takes up only very little installation space on account of the freeform surface. In other words, it also makes a considerable contribution to an improvement in the imaging quality of a head-up display having a compact design.

The optical element having the freeform surface may be designed to be reflective and/or transmissive. In particular, the optical element may be a freeform mirror.

In another preferred embodiment, the at least one spectral range diffracted by the holographic beam adaptation component comprises at least two, preferably three spectral ranges, in particular a red, a green and/or a blue spectral range, wherein the at least one bandpass filter is transmissive for visible light in at least a first and a second, and preferably also a third spectral range, wherein these each comprise the plurality of spectral ranges diffracted by the holographic beam adaptation component and wherein the bandpass filter is preferably configured to suppress visible light outside the first, second and preferably third spectral range.

This makes it particularly easy to achieve interfering light suppression for an RGB HUD.

In another preferred embodiment, the at least one spectral range diffracted by the holographic beam adaptation component comprises at least a green spectral range and a red and/or blue spectral range,
wherein the bandpass filter is transmissive for visible light in the green spectral range,
wherein the bandpass filter furthermore comprises a short-pass filter that is transmissive for visible light in the blue spectral range and is non-transmissive for wavelengths above the blue spectral range and/or
wherein the bandpass filter furthermore comprises a long-pass filter that is transmissive for visible light in the red spectral range and is non-transmissive for wavelengths below the red spectral range.

Said additional filters have two mutually separate spectral ranges or wavelength ranges, wherein the filters transmit in a first range and are non-transmissive in a second range. In the case of the short-pass filter, the first range is that of short-wave wavelengths and the second range is the long-wave range; in the case of the long-pass filter, the opposite is the case. In other words, the short-pass filter transmits light up to a maximum wavelength and is non-transmissive above this, whereas the long-pass filter transmits light from a minimum wavelength and is non-transmissive below this.

The filters are preferably configured or coordinated with one another here such that they do not affect the operation, in particular the transmission window of the respective other filter. By way of example, this may involve a filter that comprises both the bandpass filter and the short pass and long pass.

Preferably, the described embodiment should be understood to mean that the bandpass filter furthermore comprises a transmission window that is transmissive for visible light in the blue spectral range (and preferably also toward shorter wavelengths—hence also the preferred designation as “short pass”). The transmission window is in particular designed here such that the bandpass filter is non-transmissive for wavelengths above the blue spectral range as far as the transmission window of the bandpass filter in the green spectral range. As an alternative or in addition, the bandpass filter furthermore comprises a transmission window that is transmissive for visible light in the red spectral range (and preferably also toward longer wavelengths—hence also the preferred designation as “long pass”). The transmission window is in particular designed here such that the bandpass filter is non-transmissive for wavelengths below the red spectral range as far as the transmission window of the bandpass filter in the green spectral range. This thus results in multiple transmission windows: a narrow transmission window in the green spectral range combined with a wide transmission window in the blue spectral range and toward smaller wavelengths and/or combined with a wide transmission window in the red spectral range and toward larger wavelengths. The resulting transmission behavior may then for example look like what is described in FIG. 9.

The embodiment described here makes use of the fact that light below the blue spectral range or above the red spectral range is barely visible or is invisible to the human eye and it is therefore not absolutely necessary to filter these wavelength ranges in order to avoid interfering light. At the same time, short-pass and long-pass filters are cheaper to manufacture and easier to install compared to bandpass filters. In particular, if the filters are contained in one or more layers that are for example applied to the holographic component, it is possible to save considerable effort compared to applying multiple bandpass filters.

In another preferred embodiment, a red spectral range comprises a wavelength of 640 nm, a green spectral range comprises a wavelength of 525 nm and/or 532 nm, and/or a blue spectral range comprises a wavelength of 446 nm and/or 460 nm.

These wavelengths are particularly well suited to standardized and available light sources. By way of example, they may be standard wavelengths of a laser light source.

In another preferred embodiment, the spectral range diffracted by the holographic beam adaptation component has a full width at half maximum of 5 nm, preferably 2 nm. Such narrow spectral ranges make it possible to achieve a good imaging quality of the HUD since, for narrower spectral ranges, diffraction by the holographic component that is more accurate and less blurred is possible and aberrations caused by the optical components of the HUD are able to be reduced as a whole. At the same time, the bandpass filter may have a narrow at least first spectral range that is advantageously adapted to the diffracted spectral range, and thus exhibit improved interfering light suppression with at the same time high imaging quality of the HUD.

In another preferred embodiment, the bandpass filter is arranged on the holographic component.

The bandpass filter is in particular applied to the carrier substrate that the holographic component preferably comprises. The holographic function of the holographic component may for example be included in an appropriately exposed photopolymer layer. This in turn is preferably applied to an appropriate carrier substrate, which for example provides mechanical stability. The setup may then for example be such that the bandpass filter is applied to one side of the carrier substrate and the photopolymer layer is applied to another side.

The carrier substrate may for example comprise glass, for example BK7, B270 or similar suitable materials known to a person skilled in the art. By using one of these materials, refractive index matching of the filter to the substrate, in particular in the case of a coating, is able to be achieved particularly well.

It is thus possible to achieve a particularly compact and integrated component. At the same time, the bandpass filter is arranged directly where it is required, and it is possible to achieve particularly simple coordination between the holographic component and the bandpass filter.

In another preferred embodiment, the holographic component is covered by a cover glass and the bandpass filter is located between the holographic component and cover glass or is arranged on the cover glass.

The cover glass may preferably be a cover that is optically transparent to the spectral range used and that protects the holographic component from mechanical influences and soiling and at the same time constitutes an esthetically attractive cover of the holographic component, for example toward the passenger compartment of the vehicle.

The cover glass may for example be made of glass, polymethyl methacrylate (PMMA) and/or polycarbonate (PC).

On the cover glass preferably means on that side of the cover glass that represents the side of the cover glass that faces away from the holographic component. In a vehicle, this is preferably the side of the cover glass that is oriented toward the passenger compartment of the vehicle and is visible to a user, for example the driver of the motor vehicle.

A bandpass filter that is arranged between the holographic component and the cover glass is advantageously also protected from mechanical influences and soiling, like the holographic component.

A bandpass filter that is arranged on the cover glass is particularly easy to manufacture (for example by coating the cover glass). Advantageously, the bandpass filter is also able to prevent reflections of ambient light on the cover glass.

In another preferred embodiment, the HUD furthermore comprises a glare trap and/or an angle filter, in particular a louvred grille.

An angle filter is preferably a filter that is transmissive for light from one or more angular ranges and is preferably configured to suppress light from other angular ranges. The at least one angular spectrum is thus advantageously able to be transmitted in a targeted manner and ambient light from other angular ranges is able to be blocked such that it cannot be diffracted on the holographic component in the direction of the eyebox.

A louvred grille as one embodiment of the angle filter is described for example in DE 10 2019 132 600 A1. By way of example, it may be an optical grating that is designed to absorb light from the environment that is incident on a first surface side of the grating at an angle of incidence within an angle of incidence range and to transmit projection light that is incident on a second surface side of the grating at an angle of incidence within a projection angular range of the HUD.

In another preferred embodiment, the bandpass filter influences the luminance of the HUD by less than 5%.

Preferably, the bandpass filter does not influence the beam guidance in any other way, or does so only negligibly.

This makes it possible to provide an interfering light-reduced HUD in an efficient manner.

In another preferred embodiment, at least one polarization filter is contained in a beam path between the holographic component and a provided eyebox of the HUD, wherein the polarization filter is transmissive for visible light of a first polarization, which comprises a polarization diffracted by the holographic beam adaptation component.

A polarization filter is preferably a filter that is transmissive for a well-defined polarization and that preferably suppresses other polarizations that deviate therefrom.

Suppression may preferably be defined in the same way, mutatis mutandis, as described above for the bandpass filter.

The well-defined polarization may preferably be a linear polarization, that is to say a polarization along a plane. It may also be a circular polarization, that is to say a polarization that may be described over time by a rotating vector.

The fact that the first polarization comprises the diffracted polarization preferably means that a projection of the diffracted polarization onto the first polarization is proportionally at least 50%, that is to say for example less than 50% of the intensity of the diffracted light is blocked by the polarization filter due to its polarization.

This value (the proportion of the projection of the diffracted polarization onto the first polarization) may also preferably be at least 60%, at least 70%, at least 80%, at least 90% and/or at least 95%.

The diffracted light preferably comprises the useful light of the HUD.

Filtering the polarization in addition to carrying out spectral filtering makes it possible to further reduce interfering light refracted into the eyebox by the holographic component, because proportions of the ambient light that do not have the first polarization are also suppressed by the polarization filter and thus cannot be diffracted.

In another preferred embodiment, the polarization filter is contained in the bandpass filter and/or the first polarization of the polarization filter deviates from a preferred polarization of the bandpass filter by less than 50%.

The fact that the polarization filter is contained in the bandpass filter makes it possible to produce a particularly compact and efficient component.

It may be the case that the bandpass filter already has a preferred polarization. This may mean that the bandpass filter is transmissive for the preferred polarization and less transmissive for another polarization that deviates from the second polarization or suppresses same.

The preferred polarization is preferably a well-defined polarization. It may preferably be a linear polarization, that is to say a polarization along a plane. It may also be a circular polarization, that is to say a polarization that may be described over time by a rotating vector.

Suppression is preferably defined in the same way as for the abovementioned polarization filter or bandpass filter, mutatis mutandis.

Less transmissive preferably denotes an attenuation of light having a polarization different from the second polarization by at least a factor of 2.

The fact that the preferred polarization deviates from the first polarization by less than 50% preferably means that the projection of the preferred polarization onto the first polarization is proportionally at least 50%, that is to say for example less than 50% of the intensity of the diffracted light is blocked by the polarization filter due to its polarization.

Preferably, the preferred polarization even deviates by less than 40%, more preferably by less than 30%, even more preferably by less than 20% and most preferably by less than 10% from the first polarization.

This coordination between the polarization filter and the bandpass filter makes it possible to achieve a particularly efficient HUD in which little useful light of the HUD is filtered out and at the same time improved suppression of interfering light is achieved.

In another preferred embodiment, the bandpass filter, the short-pass filter and/or the long-pass filter are/is applied directly to the holographic component as at least one layer.

The at least one layer may be for example a dielectric layer system (that is to say preferably a system comprising multiple layers). This layer system may for example comprise 50-100 individual layers. These are preferably applied by way of physical vapor deposition (PVD). Particularly preferably, this may be an ion-assisted PVD process; in particular, in each case at least one low-refraction and one high-refraction oxide is used here to obtain the desired optical properties.

Preferably, the at least one layer, as already described above, is applied to the carrier substrate of the holographic component.

Application as a layer makes it possible to provide a compact component that has essential functionalities for operating the HUD without interfering light.

In another preferred embodiment, the HUD has at least one coating that is configured to minimize the deflection of incident ambient light into the eyebox.

In another preferred embodiment, the HUD is manufactured by way of the following steps:
preferably providing an HUD
determining angular ranges of ambient light irradiating onto the HUD for which a critical deflection from the HUD into the eyebox may take place (preferably by way of a computer-implemented method)
applying at least one coating to the HUD that is configured to minimize the deflection of the irradiating ambient light from the determined angular range.

This embodiment is preferably also described in DE 102022214244, the content of which is hereby considered to be incorporated into this disclosure.

An anti-reflective effect of an HUD describes in particular a process in which the deflection of ambient light irradiating onto the HUD into the eyebox of the HUD is minimized in order thus to minimize interfering light in the user's field of view.

The deflection may concern any physical effects, for example scattering, that may change the direction of the light. Deflection encompasses for example reflection, refraction and/or diffraction.

Ambient light is in this case in particular any light emitted by natural or artificial light sources and is not used to display information by way of the HUD (the light of the imager of the HUD is for example not ambient light).

The eyebox is preferably a fixed size when designing an HUD, but is implemented only when the HUD is installed. Reference is therefore preferably also made to a defined eyebox.

Provision of an HUD describes in particular the provision of all or the essential components that are required for the operation of an HUD. These comprise for example imagers, optical components (in particular for beam adaptation), beam traps, cover glass and/or glare trap.

Since it is possible to provide an HUD even before it is installed, for example in a vehicle, the projection surface, which is often contained in a pane (for example windscreen) permanently installed in the vehicle, does not have to be included here. However, the provision of the projection surface may also be included when the HUD is provided.

An HUD may also be provided only after installation, for example in a vehicle. Then, in addition to what is mentioned above, the projection surface may preferably already be included at provision. Other components, such as for example electrical components, electrical power connections, etc., may also be included.

It is important, at provision, to provide the components of the HUD (whether before or after installation) that are essential for the anti-reflective effect, that is to say on which or as a result of which a critical deflection occurs. These are in particular optical beam adaptation components (for example wavefront manipulator or holographic beam adaptation component) and/or a cover glass.

A critical deflection concerns an unwanted deflection into the eyebox and/or the safety eyebox. By way of example, any deflection may be unwanted here, or deflection above a certain threshold value. These are different embodiments and will be explained in more detail below.

Since not all ambient light is critically deflected from all directions, the idea is to determine the at least one angular range from which a critical deflection takes place. The at least one angular range thus preferably does not comprise all angles from all possible directions. By way of example, the determination may take place through computation or simulation. A simulation may in this case take place in computer-implemented fashion or using a simulation setup.

The angular range encompasses for example 60° or less, 50° or less, 40° or less, 30° or less, 20° or less or 10° or less.

A computation may typically be computer-implemented. Computer-implemented may mean that a computer comprising at least one processor and at least one data memory is provided for suitable simulation methods. During the computation and/or computer-implemented simulation, certain assumptions about the irradiated ambient light, for example the spectrum and/or direction, may be taken as a basis, as may specific geometric assumptions about the arrangement and dimension of the HUD in the installed state. Furthermore, it is possible to assume certain physical equations and/or models that specifically define the deflection and that advantageously take into account physical properties of the components of the HUD.

A simulation setup may also or additionally comprise an illumination system that is used as a model for ambient light and a measurement setup that is able to determine deflection into the eyebox and the origin of the deflected light. By way of example, an HUD installed in a vehicle may be illuminated from different directions in a time-resolved manner and the corresponding measurement may be carried out in a time-resolved manner as well, in order to be able to assign measured light to the irradiated light. A simulation setup may in this case preferably be implemented on an original HUD and/or an original vehicle or else on a model that preferably has only subcomponents and/or is reduced compared to the original.

The at least one angular range may comprise multiple angular ranges. These angular ranges may also refer to multiple preferably orthogonal planes in which they are each defined. The angular range is determined here such that it is clearly defined for a person skilled in the art. It may be a reference axis/plane, for example a normal to the surface of the HUD or the respective component of the HUD, in particular a normal in the (geometric) centroid of the surface of the component when the surface of the component is curved. This may then for example be a normal to a tangent of the surface at the respective point. As an alternative, multiple angular ranges may be determined for respective normals at different points of the surface. Determining the angular range in this case preferably comprises the information about the reference axis or plane and about the component of the HUD for which the angular range was determined.

Another essential idea is that of subsequently applying at least one coating to the HUD that is configured to minimize the deflection of the irradiating ambient light from the determined angular range. By way of example, this may be an AR coating that is designed specifically to suppress reflections for the determined angular range. This may advantageously work for a wide spectrum, but is designed specifically for the at least one determined angular range and is thus less complex than coatings from the prior art. By way of example, it does not need to include as many layers.

The coating is preferably applied to the at least one component of the HUD that ensures the critical deflection. If multiple components of the HUD are involved in the critical deflection, the coating is applied at least to the component on which the ambient light is incident first.

The coating may be carried out for example by application, adhesive bonding, deposition and/or spraying. The coating may for example be present as a foil before being applied, and then adhesively bonded (in the correct orientation according to the determined angular range).

The process may be used, in a targeted manner, to apply a coating for the angular ranges for which an unwanted deflection into the eyebox would otherwise actually take place. There is no need to use any elaborate and expensive coating that works the same for all directions. This makes it possible to save costs and allows a simpler setup that is suitable for mass production. At the same time, the angular ranges only need to be determined once, which therefore does not involve a great deal of additional effort.

In particular, the combination with the abovementioned aspect relating to a (bandpass) filter is able to particularly effectively avoid interfering light in the eyebox. Under some conditions, it may namely be the case that the filter is reflective in its blocking range and therefore does not contribute to suppressing critical reflections into the eyebox. The additional coating nevertheless makes it possible to prevent a critical deflection for the determined angular ranges.

In a further aspect, the invention relates to a holographic beam adaptation component, in particular a wavefront manipulator, for a stray light-reduced HUD, preferably as described above, having at least one bandpass filter that is arranged so as to lie in a beam path between the holographic component and a provided eyebox of the HUD. In this case, the bandpass filter is transmissive for visible light in at least a first spectral range, which comprises at least one spectral range diffracted by the holographic beam adaptation component, and is preferably configured to suppress visible light above and below the first spectral range.

It is obvious to a person skilled in the art that advantages, definitions and embodiments of the device according to the invention as per the first aspect also apply to the claimed device according to the invention as per the further aspect.

In a further aspect, the invention relates to a process for manufacturing a holographic beam adaptation component, preferably as described herein, for a stray light-reduced HUD, preferably as described herein, comprising the following steps:
a. providing the holographic beam adaptation component, which is configured to carry out beam adaptation of at least one spectral range through diffraction,
b. coating the holographic beam adaptation component with at least one first layer, wherein the at least one first layer is configured to comprise at least one bandpass filter in a beam path between the holographic component and a provided eyebox of the HUD, wherein the bandpass filter is transmissive for visible light in at least a first spectral range, which comprises the spectral range diffracted by the holographic beam adaptation component.

It is obvious to a person skilled in the art that advantages, definitions and embodiments of the device according to the invention as per the first aspect or the further aspects also apply to the process according to the invention, and vice versa.

The at least one first layer preferably comprises multiple layers, and in particular a layer system. In this case, the layer system is preferably configured to form the at least one filter. By way of example, the layers may comprise partially reflective layers that are configured to produce the preferred filter behavior through interference effects.

In one preferred embodiment, the at least one spectral range diffracted by the holographic beam adaptation component comprises at least two, preferably three spectral ranges, in particular a red, a green and/or a blue spectral range,
wherein the at least one bandpass filter is transmissive for visible light in at least a first and a second, and preferably also a third spectral range, wherein these each comprise the multiple spectral ranges diffracted by the holographic beam adaptation component.

In another preferred embodiment, the at least one spectral range diffracted by the holographic beam adaptation component comprises at least a green spectral range and a red and/or blue spectral range,
wherein the bandpass filter is transmissive for visible light in the green spectral range,
wherein a short-pass filter is also included, this being transmissive for visible light in the blue spectral range and non-transmissive for wavelengths above the blue spectral range and/or
wherein a long-pass filter is also included, this being transmissive for visible light in the red spectral range and non-transmissive for wavelengths below the red spectral range.

In a further aspect, the invention relates to a holographic beam adaptation component, in particular a wavefront manipulator, for a stray light-reduced HUD, preferably in accordance with what is described herein, manufactured by a process as described herein.

It is obvious to a person skilled in the art that advantages, definitions and embodiments of the device according to the invention as per the first aspect or the further aspects and of the process according to the invention also apply to this device according to the invention, and vice versa.

### BRIEF DESCRIPTION OF THE DRAWINGS

The invention will be elucidated hereinafter with reference to further figures and examples. The examples and figures serve to illustrate preferred embodiments of the invention without limitation.

FIG. 1 shows different interfering light components in an HUD according to the prior art.

FIG. 2 considers interfering light due to Fresnel reflections of ambient light on the surface of the wavefront manipulator.

FIG. 3 illustrates interfering light that arises as a result of ambient light diffracted on the holographic beam adaptation component.

FIG. 4 shows the proportion of the interfering light caused by ambient light reflected from the mirror.

FIG. 5 shows the proportion of the interfering light caused by ambient light reflected from the imager.

FIG. 6 shows an exemplary HUD according to one embodiment of the invention.

FIG. 7 shows components of a wavefront manipulator having a bandpass filter.

FIG. 8 shows the spectral transmission properties of an exemplary bandpass filter.

FIG. 9 shows the spectral transmission properties of an exemplary combination of a bandpass filter, long-pass filter and short-pass filter.

FIG. 10 shows the (undisturbed) beam path of an HUD having a bandpass filter.

FIG. 11 shows the process steps of one embodiment of the process.

### DETAILED DESCRIPTION

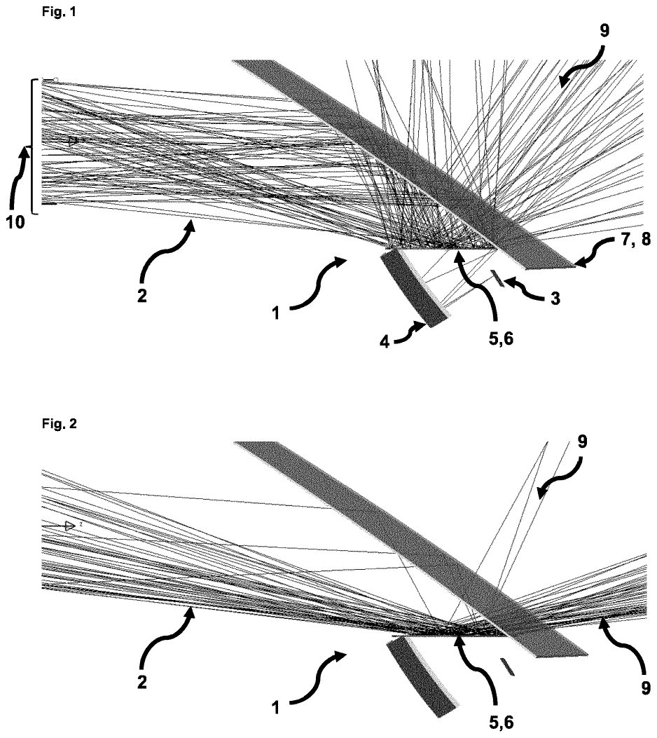

FIG. 1 shows an HUD 1 and the interfering light 2 resulting from deflected ambient light 9 (simulation), said interfering light being steered in the direction of the (safety) eyebox, wherein no measure for suppressing this has been provided here. The HUD 1 that is shown comprises the components imager (PGU) 3, (freeform) mirror 4, holographic beam adaptation component 5, here in the form of a wavefront manipulator 6 and projection surface 7 in the form of a windscreen 8 of a vehicle. The wavefront manipulator may be covered by a cover glass (not explicitly shown). The (vertical extent of the) eyebox 10 is located to the left of the windscreen in the emission field of the interfering light 2.

Following FIGS. 2-5 show a decomposition of the interfering light 2 into its individual components or in accordance with its original component in the HUD 1.

FIG. 2 considers interfering light 2 due to Fresnel reflections of ambient light 9 on the surface of the wavefront manipulator.

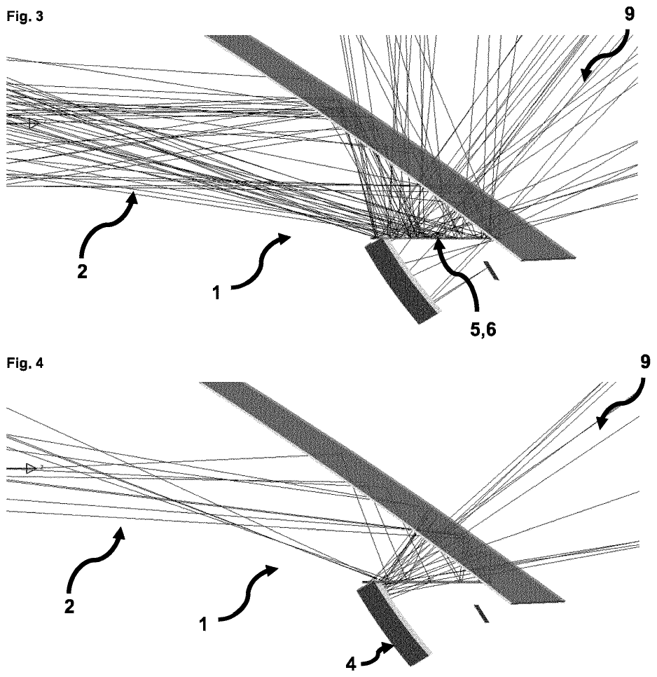

FIG. 3 illustrates interfering light 2 that arises as a result of ambient light 9 diffracted on the holographic beam adaptation component 5 (here also wavefront manipulator 6).

FIG. 4 shows the proportion of the interfering light 2 caused by ambient light 9 reflected from the mirror 4.

FIG. 5 shows the proportion of the interfering light 2 caused by ambient light 9 reflected from the imager 3.

If the components of the interfering light are broken down (see Tab. 1 below), these components landing in the eyebox due to various unwanted deflections, this has the result that the proportion of Fresnel reflections is by far the greatest on the components of the HUD 1, here on the wavefront manipulator 6. This proportion is able to be greatly reduced through appropriate measures, for example by applying appropriate layers for the determined angular ranges of the deflected ambient light, as described in this document. Tab. 1 does not show the proportion of interfering light that lands directly in the eyebox, that is to say without deflection.

The next-largest proportion results from the diffraction on the holographic beam adaptation component 5. In the table, this is furthermore broken down in accordance with the different wavelengths for which the holographic subcomponents included in the computed example are each designed. According thereto, the holographic interfering deflections make up about one third of the total interfering light 2 and are therefore significant.

TABLE 1

| Origin | Proportion (radiometric evaluation) |
|---|---|
| Fresnel reflections | 67.76% |
| Mirror | 0.11% |
| PGU | 0.01% |
| Blue HOE | 7.46% |
| Green HOE | 12.62% |
| Red HOE | 10.95% |

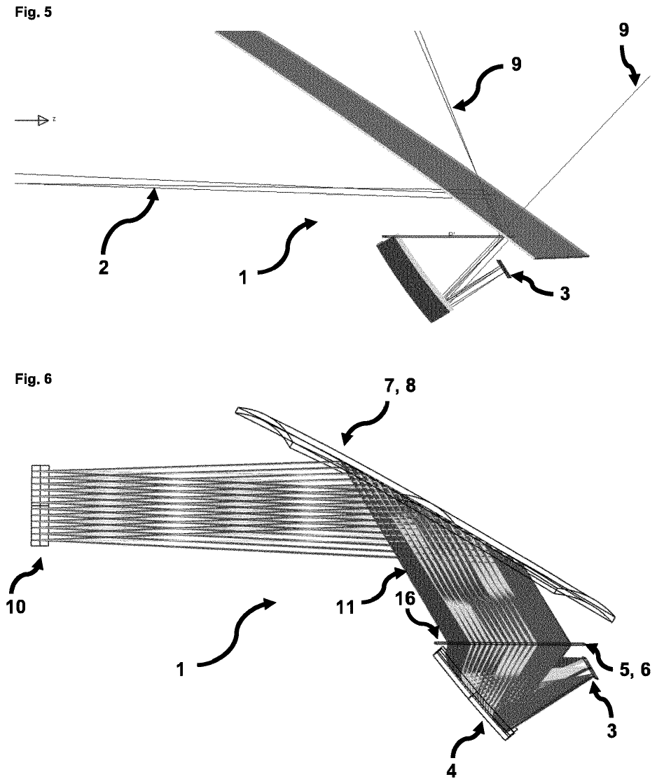

FIG. 6 shows an exemplary HUD 1 according to one example embodiment. The components correspond largely to those of the HUD 1 according to FIG. 1 and are therefore not explained in full again. Additionally shown here are the eyebox 10 and the deflected beam path of the HUD 11 that is generated for the operation of the HUD 1. Essential features are encompassed in the holographic beam adaptation component 5 (the wavefront manipulator 6).

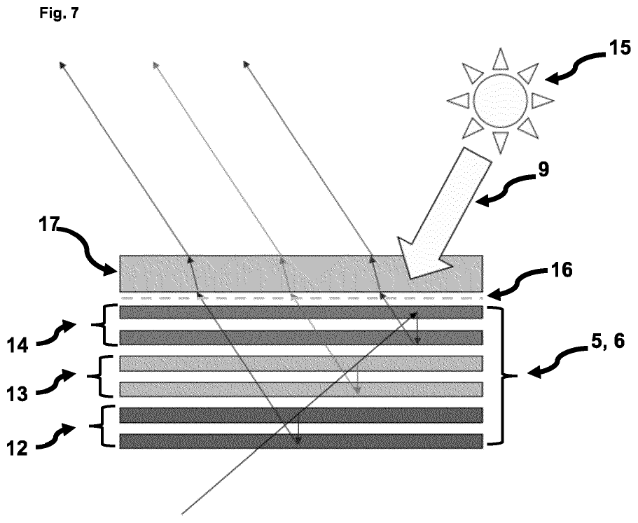

This component is therefore illustrated again in enlarged form in FIG. 7. The holographic beam adaptation component 5 that is shown, in the form of a wavefront manipulator 6, consists of what is referred to as a hologram stack consisting of reflection holograms 12, 13 and 14 (referred to as Z holograms) that are arranged in pairs with one another and are each designed to diffract a specific spectral range. These reflection holograms arranged in pairs with one another are preferably each holograms or holographic elements assigned to one another as described above in the summary in relation to the wavefront manipulator. The bottom pair 12 is designed to diffract blue light and could for example correspond to the blue HOE in Tab. 1, the middle pair 13 is designed for green light and could therefore correspond to the green HOE in Tab. 1, and the top pair 14 diffracts red light and could thus correspond to the red HOE in Tab. 1. As a result of the respective pairs 13, 14, 15, the wavefronts of the HUD 1 coming from the imager 3 via the mirror 4 are able to be influenced as desired in the respective spectral range by virtue of a desired diffraction function having been introduced into the respective holograms. Exemplary light beams are illustrated here by the arrows. The spectral design of the respective pairs 12, 13, 14 advantageously corresponds here to the respective spectral ranges, emitted by the imager 3, in the red, green and blue. Such RGB imaging methods (RGB here stands for red, green and blue) for producing a white or color image are well known to a person skilled in the art and do not need to be described in more detail here. Ambient light 9, for example from the sun in the sky, which has been illustrated symbolically here (reference numeral 15), contains a wide spectrum and thus also the spectral ranges for which the respective pairs 12, 13, 14 are designed, but also spectral ranges adjacent to these spectral ranges. A person skilled in the art knows that a hologram that diffracts light of a certain wavelength from a certain direction in a certain direction diffracts light of an adjacent wavelength from the same direction in an adjacent direction and, in some cases, light of other wavelengths from another direction in the certain direction. Therefore, without further measures, there may be unwanted deflection of this light on the wavefront manipulator 6, which could lead to interfering light in the eyebox 10. The penetration of ambient light 9 into the wavefront manipulator 6 is however largely prevented by a bandpass filter 16 that is located above the wavefront manipulator and that is transmissive only for the respective spectral range for which the pairs 12,13 and 14 are designed. Optionally, in addition to a bandpass filter 16 for green light, a short-pass filter for blue light and a long-pass filter for red light may also alternatively be included. It is thus possible to significantly reduce unwanted deflection of other spectral ranges from ambient light 9 into the eyebox 10 and minimize interfering light. FIG. 7 likewise shows a cover glass 17 covering the wavefront manipulator 6 and the bandpass filter 16. This may serve as an optical cover on a purely esthetic basis, but may have other functionalities, such as for example a coating for minimizing Fresnel reflections into the eyebox 10 or protection against soiling (for example dust) of the manipulator 6. The bandpass filter 16 may itself be composed of multiple filter elements (for example bandpass filter, long-pass filter and/or short-pass filter) in order to have the desired spectral properties.

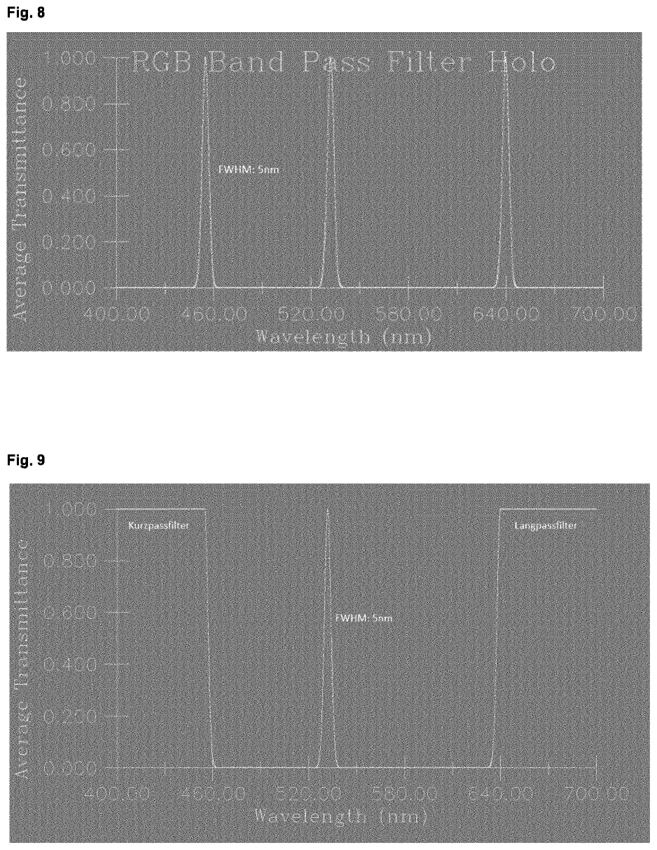

FIG. 8 shows the spectral transmission properties of an exemplary bandpass filter. The bandpass filter has been adapted to the RGB wavelengths used for the HUD 1 and for which the holographic subcomponents are designed. Transmission is maximum for these wavelengths, and the spectral “transmission windows” in this case each have a full width at half maximum (FWHM) of 5 nanometers (nm).

FIG. 9 shows the spectral transmission properties of one embodiment that combines an exemplary bandpass filter with a respective short-pass filter and long-pass filter. In this case too, the filters have been adapted to the RGB wavelengths used for the HUD 1 and for which the holographic subcomponents are designed. The short-pass filter is transmissive for visible light in the blue spectral range of the HUD 1 and non-transmissive for wavelengths above the blue spectral range. The long-pass filter is transmissive for visible light in the red spectral range of the HUD 1 and non-transmissive for wavelengths below the red spectral range. The bandpass filter, in turn, is transmissive for the green spectral range of the HUD 1. Thus, although in each case wavelengths below the blue or above the red spectral range are transmitted, since they are in a range that is barely visible or even invisible to the eye, interfering light from this wavelength range may be accepted in some cases. At the same time, this embodiment simplifies manufacture.

When using such a filter, the above simulation in Table 1 was repeated and refined, see Tab. 2. The table in this case shows, on the one hand, on the left, the interfering light components without the use of a filter and, on the other hand, on the right next thereto, the interfering light components when using an embodiment according to the embodiment as described in FIG. 8 and, on the far right, when using an embodiment as described in FIG. 9. The interfering light components are again broken down into the respective original locations and types. The respective percentage proportion of the total interfering light that finds its way into the eyebox is shown once as a radiometric evaluation and once as a photometric evaluation that, in addition to the radiometric evaluation, also takes into account the sensitivity of the human eye to the respective wavelengths. Again, the greatest proportion is formed by the Fresnel reflections on an HUD component, which cannot be reduced by using the filter. This proportion increases once again when using the filters, because less interfering light is now produced by diffraction on the HOEs, and the relative proportion of the interfering light thereby increases toward Fresnel reflections. In any case, it becomes clear that the interfering light proportions from the holographic component are able to be reduced significantly when filters are used. As expected, the embodiment with short-pass and long-pass filters performs somewhat worse than the embodiment that uses bandpass filters for all spectral ranges.

TABLE 2

| | | | | | Long-pass/short- | |
|---|---|---|---|---|---|---|
| | Without filters | | RGB bandpass filter | | pass/bandpass filter | |
| | radiometric | photometric | radiometric | photometric | radiometric | photometric |
| Fresnel | 67.76% | 58.06% | 97.90% | 98.00% | 86.73% | 96.76% |
| Mirror | 0.11% | 0.12% | 0.005% | 0.008% | 0.06% | 0.01% |
| PGU | 0.007% | 0.008% | 0.004% | 0.005% | 0.006% | 0.006% |
| HOE red | 12.52% | 29.94% | 0.39% | 0.52% | 2.32% | 1.35% |
| HOE green | 12.65% | 12.36% | 1.39% | 1.44% | 2.69% | 1.60% |
| HOE blue | 7.45% | 0.47% | 0.35% | 0.07% | 8.22% | 0.34% |

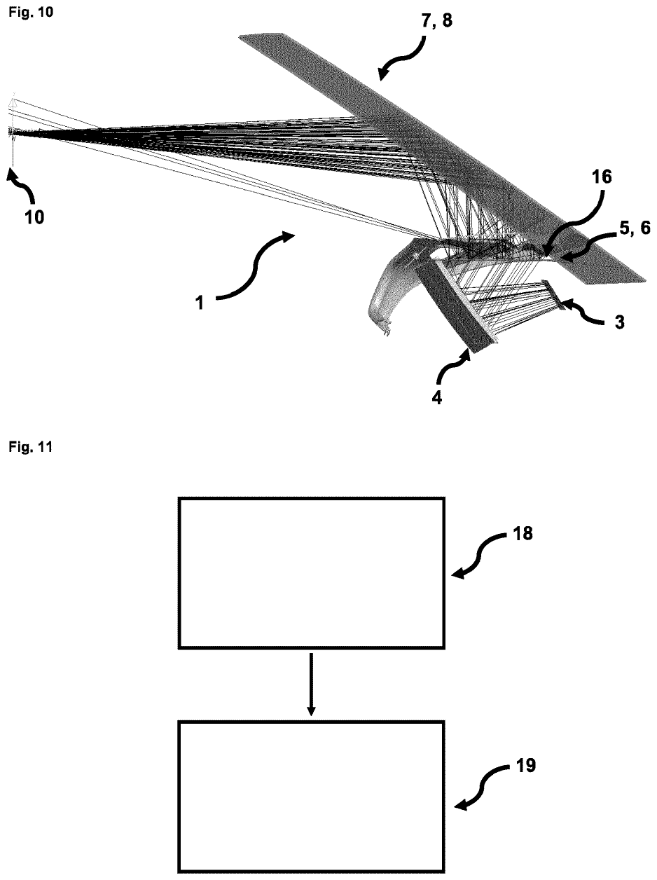

The simulation illustrated in FIG. 10 shows that the beam path 11 of the HUD 1 is not affected by the use of the bandpass filter 16. The light density distribution (not shown) is also not affected by the bandpass filter 16. FIG. 9 here shows the HUD having a filter 16, and the components of the HUD 1 that are shown are otherwise identical to for example FIG. 1 and are therefore not described here again in detail.

FIG. 11 shows one exemplary embodiment of the process for manufacturing the holographic beam adaptation component. The process preferably comprises the steps of “providing the holographic beam adaptation component” 18 and “coating the holographic beam adaptation component with at least one first layer that comprises the bandpass filter” 19.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

### LIST OF REFERENCE SIGNS

1 HUD
2 Interfering light
3 Imager (PGU)
4 (Freeform) mirror
5 Holographic beam adaptation component
6 Wavefront manipulator
7 Projection surface
8 Windscreen
9 Ambient light
10 Eyebox
11 Beam path of the HUD
12 Pair of holograms for blue spectral range
13 Pair of holograms for green spectral range
14 Pair of holograms for red spectral range
15 Sun
16 Bandpass filter
17 Cover glass
18 Providing the holographic beam adaptation component
19 Coating the holographic beam adaptation component with at least one first layer that comprises the bandpass filter

1-17. (canceled)

18. A stray light-reduced head-up display (HUD), comprising:
an eyebox;
a holographic beam adaptation component; and
at least one bandpass filter arranged in a beam path between the holographic beam adaptation component and the eyebox,
wherein the bandpass filter is transmissive for visible light in at least a first spectral range, which comprises at least one spectral range diffracted by the holographic beam adaptation component.

19. The HUD of claim 18, wherein the first spectral range has a full width at half maximum of at most 20 nm.

20. The HUD of claim 18, wherein the first spectral range has a full width at half maximum of at most 10 nm.

21. The HUD of claim 18, wherein the first spectral range has a full width at half maximum of at most 5 nm.

22. The HUD of claim 18, wherein an acceptance angular spectrum of the bandpass filter comprises an angular spectrum of 10, and wherein the acceptance angular spectrum comprises a centroid angle of the angular spectrum diffracted by the holographic beam adaptation component.

23. The HUD of claim 18, wherein an acceptance angular spectrum of the bandpass filter comprises an angular spectrum of 5°, and wherein the acceptance angular spectrum comprises a centroid angle of the angular spectrum diffracted by the holographic beam adaptation component.

24. The HUD of claim 18, wherein the acceptance angular spectrum of the bandpass filter comprises an angular spectrum diffracted by the holographic beam adaptation component and/or its centroid angle and is at most 2° larger than the diffracted angular spectrum.

25. The HUD of claim 18, wherein the holographic component comprises a wavefront manipulator arranged in the beam path of the HUD between a picture generating unit and a projection surface.

26. The HUD of claim 18, wherein the at least one spectral range diffracted by the holographic beam adaptation component comprises at least a red, a green and a blue spectral range, wherein the at least one bandpass filter is transmissive for visible light in at least the red, the green and the blue spectral ranges, and wherein these each comprise the multiple spectral ranges diffracted by the holographic beam adaptation component.

27. The HUD of claim 18, wherein the at least one spectral range diffracted by the holographic beam adaptation component comprises at least a green spectral range and a red and/or blue spectral range, wherein the bandpass filter is transmissive for visible light in the green spectral range, and
wherein the bandpass filter furthermore comprises a short-pass filter that is transmissive for visible light in the blue spectral range and is non-transmissive for wavelengths above the blue spectral range, and/or
wherein the bandpass filter furthermore comprises a long-pass filter that is transmissive for visible light in the red spectral range and is non-transmissive for wavelengths below the red spectral range.

28. The HUD of claim 27, wherein a red spectral range comprises a wavelength of 640 nm, a green spectral range comprises a wavelength of 525 nm and/or 532 nm, and/or a blue spectral range comprises a wavelength of 446 nm and/or 460 nm.

29. The HUD of claim 18, wherein the spectral range diffracted by the holographic beam adaptation component has a full width at half maximum of 5 nm.

30. The HUD of claim 18, wherein the holographic component is covered by a cover glass, and wherein the bandpass filter is arranged between the holographic component and the cover glass or on the cover glass.

31. The HUD of claim 18, furthermore comprising a glare trap, an angle filter, and/or a louvred grille.

32. The HUD of claim 18, wherein at least one polarization filter is contained in a beam path between the holographic component and the eyebox, wherein the polarization filter is transmissive for visible light of a first polarization, which comprises a polarization diffracted by the holographic beam adaptation component, wherein the polarization filter is contained in the bandpass filter and/or the first polarization of the polarization filter deviates from a preferred polarization of the bandpass filter by less than 50%.

33. The HUD of claim 18, wherein the bandpass filter, a short-pass filter and/or a long-pass filter are/is applied directly to the holographic component as at least one layer.

34. The HUD of claim 18, wherein the holographic beam adaptation component comprises a wavefront manipulator.

35. A method of manufacturing the HUD of claim 18, wherein the HUD comprises at least one coating that is configured to minimize the deflection of incident ambient light into the eyebox, the method comprising:
determining angular ranges of ambient light irradiating onto the HUD for which a critical deflection from the HUD into the eyebox may take place; and
applying at least one coating to the HUD that is configured to minimize the deflection of the irradiating ambient light from the determined angular ranges.

36. A method of manufacturing a holographic beam adaptation component for a HUD, the method comprising:
providing the holographic beam adaptation component, which is configured to carry out beam adaptation of at least one spectral range through diffraction,
coating the holographic beam adaptation component with at least one first layer, wherein the at least one first layer is configured to comprise at least one bandpass filter in a beam path between the holographic component and an eyebox of the HUD,
wherein the bandpass filter is transmissive for visible light in at least a first spectral range, which comprises the spectral range diffracted by the holographic beam adaptation component.

37. The method of claim 36, wherein the holographic beam adaptation component comprises a wavefront manipulator.
